(19) United States
(12) Patent Application Publication
(10) Pub. No.: US 2005/0283259 A1
(43) Pub. Date: Dec. 22, 2005

(54) Dispensing system with real time inventory management

(76) Inventor: Richard A. Wolpow, Newport Beach, CA (US)

Correspondence Address: STETINA BRUNDA GARRED & BRUCKER, 75 ENTERPRISE, SUITE 250, ALISO VIEJO, CA, 92656, US

(21) Appl. No.: 10/874,878

(22) Filed: Jun. 22, 2004

(51) Int. Cl. G06F 17/00

(52) U.S. Cl. 700/22

(57) ABSTRACT

An integrated dispensing and inventory tracking system is provided for use in conjunction with a medical practice. Data records of inventoried items, such as repackaged drugs or other medical supplies, can be maintained by the system and accessed by a user through a graphical user interface displayed by a browser. The data records can include information pertaining to user-defined inventory categories, minimum and maximum quantities associated with tracked inventory items, quantities on hand associated with tracked inventory items, lot numbers associated with tracked inventory items, and/or related information. Inventory data records can be updated in real time in response to dispensing transactions and/or deliveries of additional inventory items. Various alert status conditions can also be detected by the system, allowing users of the system to be notified of circumstances requiring immediate attention.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

Traditional methods of dispensing prescribed medications are well known to consumers and medical practitioners. Typically, a consumer receives a drug prescription from a doctor and then proceeds to have the prescription filled by a separate retail pharmacy. Unfortunately, when separate entities are used for prescribing and providing medication, errors can be introduced into the dispensing process which result in improper dispensing of medication and, ultimately, harm to patients.

To reduce such risks, doctors may provide on-site dispensing of certain prescriptions through the use of repackaged drugs. Although on-site dispensing can provide doctors with a source of potential income, any revenue stream derived from on-site dispensing may be impeded by the significant administrative costs associated with providing such services. For example, it can be exceedingly cumbersome for doctors to maintain accurate records of on-site dispensing transactions. Moreover, it is important for doctors to know what drugs are available for dispensing, and whether quantities of drugs on hand have reached critical levels. Nevertheless, the considerable time and effort required to keep up to date with such information can render the entire dispensing process inefficient.

Accordingly, there exists a need for a comprehensive system which provides a streamlined approach to on-site dispensing of medical supplies, while simultaneously providing for the tracking of medical supplies and/or other inventory maintained by a medical practice. It would be desirable for such a system to permit access to dispensing transaction records, as well as other data records related to the dispensing and tracking of inventoried items.

### BRIEF SUMMARY OF THE INVENTION

The present invention, roughly described, is directed to technology for providing an integrated dispensing and inventory tracking system for use in a medical practice. In various embodiments, the system can include a server in communication with the Internet, a web site provided by the server, application software running on the server for tracking inventory of a medical practice, and data records stored by the server. Such data records can include information pertaining to a user-defined inventory category, a minimum quantity associated with a tracked inventory item, a maximum quantity associated with the tracked inventory item, a quantity on hand associated with the tracked inventory item, a lot number associated with the tracked inventory item, and/or other information further described herein. A user situated in an office of a medical practice can access functionality provided by the server by logging in to the web site provided by the server and interacting with the server through a graphical user interface displayed by a browser.

In certain embodiments, the system can provide functionality for managing the inventory of a medical practice. Data records associated with repackaged drugs or other items to be dispensed by the medical practice can be maintained. Lot numbers associated with such items can be verified in conjunction with dispensing transactions, thereby reducing dispensing errors and related problems. Inventory data records can be updated in real time in response to a dispensing transaction. Records of dispensing transactions, including lot number information, can be stored by the system for subsequent review by users of the system.

In other embodiments, deliveries of inventory items can be tracked and stored as data records by the system. Various alert status conditions can be detected by the system, allowing users of the system to be notified of circumstances requiring immediate attention. For example, if the quantity of a tracked inventory item falls below a specified minimum amount, users can be notified and presented with the option to order additional inventory. In various embodiments, the system also facilitates the generation of reports based on the data records maintained by the system.

These and other embodiments of the present invention are discussed in further detail below.

### BRIEF DESCRIPTION OF THE DRAWINGS

FIG. 1 is a block diagram illustrating various components of an integrated dispensing and inventory tracking system, and related elements that interact with the system, in accordance with an embodiment of the present invention.

FIG. 2 illustrates a login screen presented to a user of an integrated dispensing and inventory tracking system in accordance with an embodiment of the present invention.

FIG. 3 illustrates a main screen presented to a user of an integrated dispensing and inventory tracking system in accordance with an embodiment of the present invention.

FIG. 4 is a flowchart describing a process for customizing formulary inventory in accordance with an embodiment of the present invention.

FIG. 5 is a flowchart describing a process for customizing inventory categories in accordance with an embodiment of the present invention.

FIG. 6 is a flowchart describing a process for adding an inventory item to an inventory category in accordance with an embodiment of the present invention.

FIG. 7 is a flowchart describing a process for adjusting inventory quantity in accordance with an embodiment of the present invention.

FIG. 8 is a flowchart describing a process for modifying inventory formulary data in accordance with an embodiment of the present invention.

FIG. 9 is a flowchart describing a process for viewing order information in accordance with an embodiment of the present invention.

FIG. 10 is a flowchart describing a process for accepting delivery of inventory in accordance with an embodiment of the present invention.

FIG. 11 is a flowchart describing a process for viewing delivery information in accordance with an embodiment of the present invention.

FIGS. 12A and 12B are flowcharts describing a process for dispensing formulary from inventory in accordance with an embodiment of the present invention.

FIG. 13 is a flowchart describing a process for dispensing formulary from a prescription queue in accordance with an embodiment of the present invention.

FIG. 14 is a flowchart describing a process for providing reports in accordance with an embodiment of the present invention.

FIG. 15 is a flowchart describing a process for providing status alerts in accordance with an embodiment of the present invention.

FIGS. 16A through 16W illustrate additional screens presented to a user of an integrated dispensing and inventory tracking system in accordance with an embodiment of the present invention.

### DETAILED DESCRIPTION OF THE INVENTION

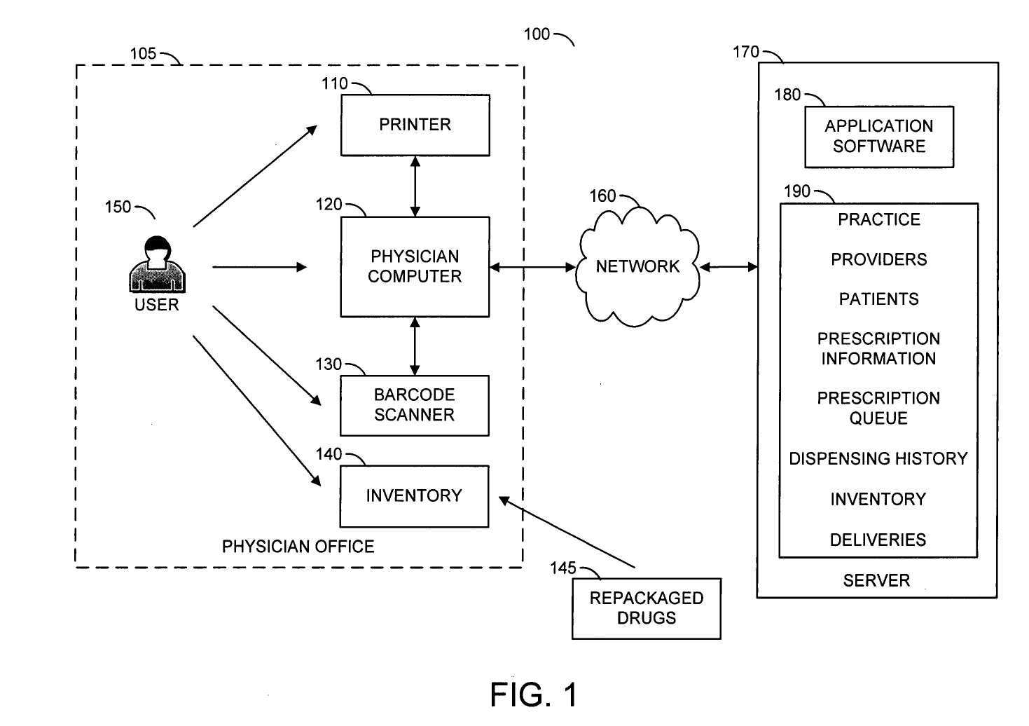

FIG. 1 is a block diagram illustrating various components of an integrated dispensing and inventory tracking system 100, and related elements that interact with the system 100, in accordance with an embodiment of the present invention. In various embodiments, system 100 can be implemented to assist medical professionals in tracking and dispensing items maintained in the inventory of a physician office.

As further described herein, various embodiments of system 100 can advantageously enable physicians and approved staff members to conveniently and safely dispense medication, such as repackaged drugs 145, from an office 105 of a medical practice. Prescribed medication can be verified at the time it is dispensed, and patient-specific labels and education sheets can be created. Patient utilization and dispensing history can be tracked, and real-time reporting can be provided with a variety of sorting options including, but not limited to: patient, prescriber, medication, site, set time periods, and/or other demographics. In various embodiments, operation of system 100 can be implemented in compliance with HIPPA requirements.

Medication and/or other inventory maintained in the office 105 can be tracked in real-time using system 100, and data associated with dispensing transactions can be stored by system 100 including, but not limited to: physician, patient, medication, and/or dispensing facility. Re-ordering alerts based on preset min-max inventory controls can be provided to users of the system, facilitating timely reordering of medication or other inventory. Delivery notifications can also be provided, with automated inventory population upon confirmation of a delivery.

As illustrated in FIG. 1, a server 170 can be provided with application software 180 for instructing the server 170 to perform various functionality described herein. Data records 190 can be stored by server 170 for use by application software 180. Such data records can include the information identified in FIG. 1, and/or any other information provided by and/or processed by server 170 in accordance with the present invention. For purposes of convenience, server 170, application software 180, and data records 190 have been illustrated as a single unit. However, it will be appreciated by those skilled in the art that plural servers are also contemplated by the present invention, and that application software 180 can be distributed across such servers. Moreover, it will also be appreciated that data records 190 can be stored in accordance with any storage technology known in the art, including but not limited to one or more separate databases.

User 150 can be any person located in an office 105 who is authorized to interact with system 100. It will be appreciated that system 100 can receive and maintain relevant information to distinguish between facility administrator users 150 and other users 150, thereby granting facility administrator users access to certain functionality (for example, the customization of inventory) while granting all users access to other functionality (such as accepting deliveries). As illustrated, user 150 can interact with printer 110, computer 120, scanner 130, and/or inventory 140 for performing various actions, as further described herein.

In various embodiments, physician computer 120 can be any appropriate computer, workstation, handheld wireless device, or other computing device known in the art capable of interacting with server 170. Physician computer 120 can communicate with server 170 over an electronic network 160. It will be appreciated that network 160 can be any of the various networks known in the art to facilitate data transmission, including but not limited to a wide area network (WAN), the Internet, a virtual private network (VPN), and/or others known in the art. It is also contemplated that the functionality provided by server 170 can be integrated into physician computer 120. In the case of Internet communication, a web browser application (such as Internet Explorer version 6 or higher) running on physician computer 120 can provide a user interface, such as a graphical user interface, for user 150 when interacting with a web site provided by server 170.

A barcode scanner 130 and printer 110 in communication with physician computer 120 can also be provided in office 105 for use by user 150, as further described herein. Inventory 140 of the office 105 can be stored in any appropriate fashion. For example, medication received in the form of repackaged drugs 145 for on-site dispensing can be stored in a dispensing cabinet and retrieved by user 150 when needed.

It will be appreciated that, as a result of the real-time tracking of inventory further described herein, recalls of tracked products can be efficiently managed. For example, if a particular product lot is to be recalled, the provider of server 170 can process data records 190 and issue a patient-specific appropriate report to any of the offices 105 that have dispensed product from the specific lot number to be recalled. Because the service provider can access any of the data records 190 maintained by server 170, such reports can identify the particular dispensing transactions of the office 105 involving the lot number in question. Such functionality allows for a targeted response to such recalls, thereby simplifying the recall process.

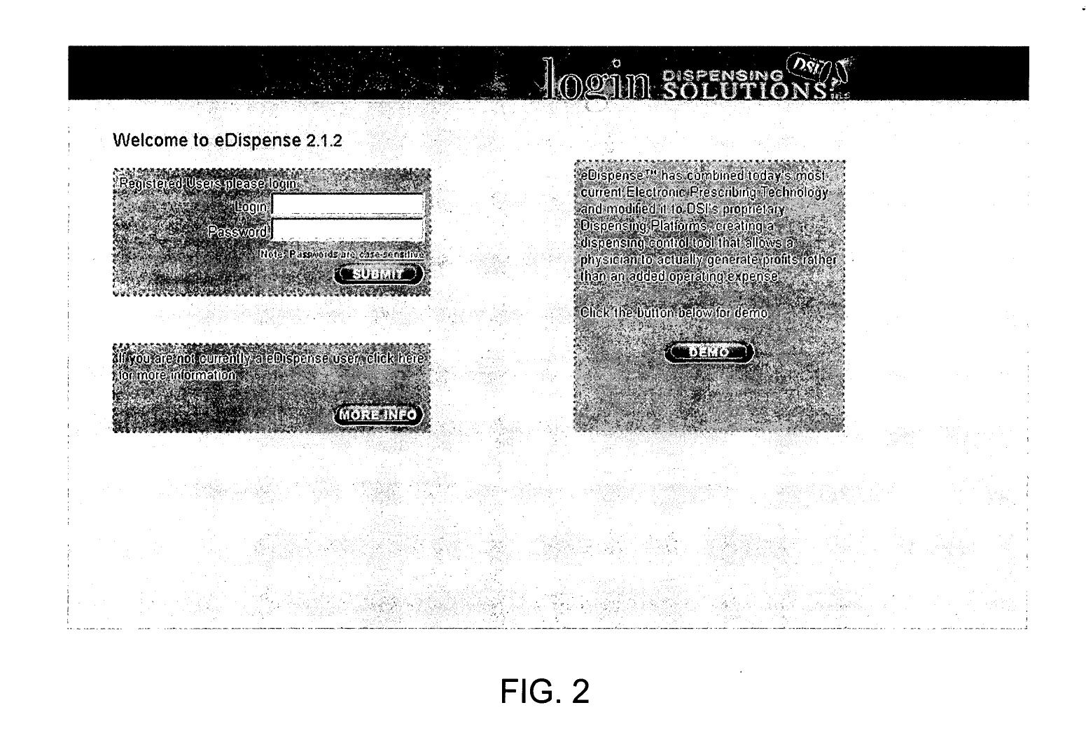

FIG. 2 illustrates a login screen presented to a user 150 of an integrated dispensing and inventory tracking system 100 in accordance with an embodiment of the present invention. When a user 150 seeks to utilize system 100, the user will typically connect to network 160 (i.e. the Internet) from physician computer 120 through a high speed Internet connection. User 150 can access a secure web site maintained by server 170 through a web browser, wherein the user 150 can be presented with a login screen of the form illustrated in FIG. 2. Upon a successful login, the user 150 can be allowed access to additional functionality of system 100 through the web site maintained by server 170.

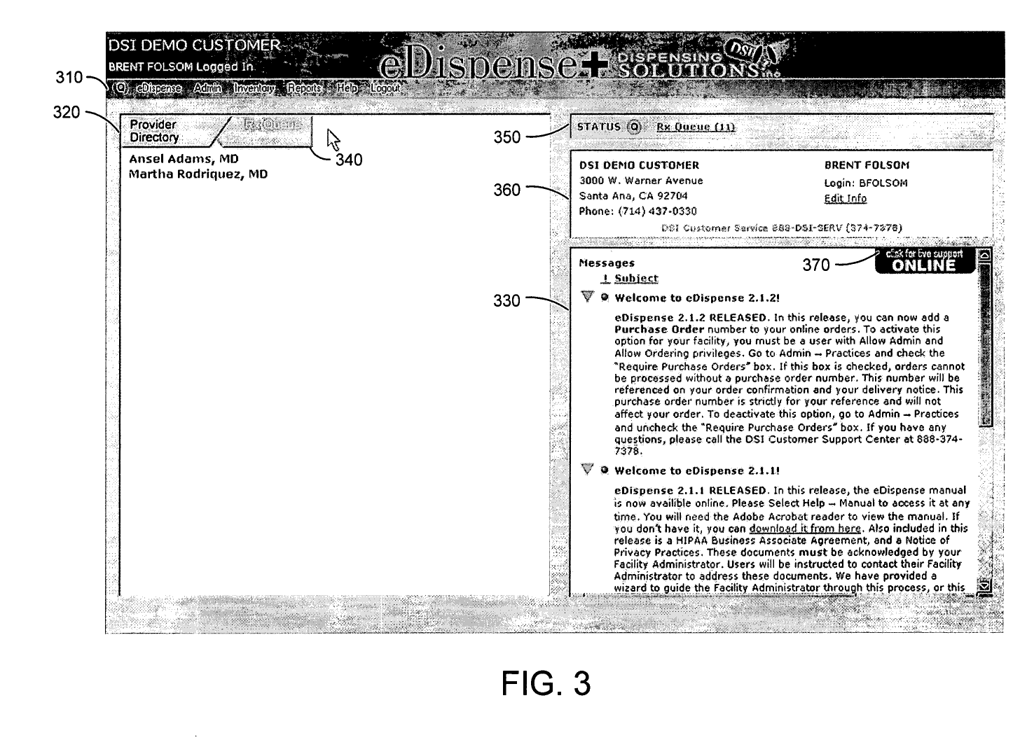

FIG. 3 illustrates a main screen which can be presented to user 150 after logging in to system 100. As illustrated, the main screen provides a menu bar 310 with a status alert light (located at the extreme left of the bar), user-selectable drop down menus, and user-selectable buttons. The status alert light can provide a visual reminder to user 150 that a reorder is necessary, a delivery is coming, a particular lot number is about to expire, and/or other conditions. Such conditions can also be displayed in status window 350 of the main screen. In the particular embodiment illustrated in FIG. 3, the status window 350 indicates that there are eleven prescriptions in the RxQueue that are waiting to be dispensed. By clicking on a link displayed in the status window 350, the user 150 can be directed to an appropriate screen for attending to the alert condition.

The “eDispense” button of menu 310 allows user 150 to return to the main screen at any time when the user 150 has navigated to a different screen provided by the web site. The “Admin” menu provides various options available to an administrator of system 100. For example, by clicking on the Admin menu, an administrator can select: “Practice” for viewing and modifying information pertaining to one or more medical practices using system 100; “Providers” for viewing and modifying information pertaining to one or more providers within a medical practice; “Users” for creating and modifying information pertaining to users 150 of system 100; “Patients” for creating and modify information pertaining to patients; and “Transactions” for managing, editing, and/or entering dispensing transactions performed using system 100.

The “Inventory” menu allows a user 150 to manage the inventory of a given medical practice. Options available under the Inventory menu can include: “Formulary” for performing real time management of formulary, such as formulary provided in the form of repackaged drugs 145; “Other Inventory” for creating and managing other inventory, such as inventory provided from other sources; “Deliveries” for tracking, accepting, and reviewing the status of deliveries of products; and “Orders” for reviewing and tracking orders.

The “Reports” menu allows a user 150 to access various reports useful in monitoring dispensing transactions and the utilization of system 100. Options available under the Inventory menu can include: “Dispensings” for accessing reports of dispensings performed using system 100; and “Daily Utilization” for accessing reports of dispensings based on a user-selectable range of dates.

The “Help” menu allows a user 150 to access a help manual, HIPAA documents, and/or information concerning the entity providing system 100. The user 150 can log out of the system 100 by pressing the “Logout” button.

It will be appreciated that one or more providers (i.e. doctors) associated with a medical practice can be authorized to prescribe medication. A provider directory tab 320 permits an authorized user 150 to display a list of the providers of office 105 for whom the user 150 is authorized to dispense medication, as illustrated in FIG. 3. It will also be appreciated that such user authorization can be granted for some, all, or none of the providers associated with a given medical practice. User-selectable tab 340 permits a user to display a list of prescriptions in a prescription queue which are waiting to be filled, as further described herein.

The main screen of FIG. 3 also provides a location window 360 which can display the name, address, and telephone number of the office 105, as well as the user ID of the user 150 presently logged in to system 100.

A message window 330 can also be provided for displaying relevant messages to user 150. Located above the message window 330 is an online help button 370, permitting a user 150 to request live online support.

In one aspect of the present invention, various embodiments of system 100 can permit an authorized user 150 to customize the inventory that is tracked by system 100. Inventory items can be generally grouped into formulary inventory, miscellaneous items, and user-defined categories (“other inventory”). By maintaining information associated with inventory items in such categories, system 100 allows authorized users 150 (such as facility administrators) to manage, dispense and track an unlimited amount of medications and supplies received from repackaged drug providers, or other sources. For example, such medications and supplies can include, but need not limited to: 340B drugs, manufacture samples, injectables, ointments, creams, crutches, neck braces, bandages, and/or any other medications or supplies desired to be maintained in office 105.

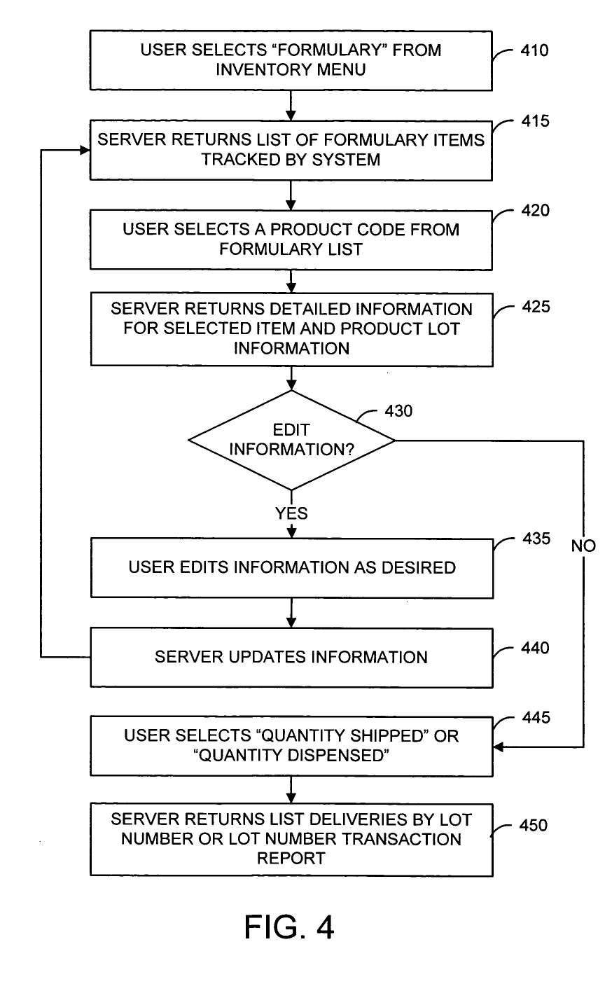

FIG. 4 is a flowchart describing a process for customizing formulary inventory in accordance with an embodiment of the present invention. At step 410, a user 150 having administrative privileges selects the “Formulary” option from the Inventory menu of menu bar 310 of FIG. 3. In response, server 170 returns a list of formulary items currently tracked in the inventory of office 105 (step 415). The formulary list can provide a real time view of the current formulary inventory on hand as well as the miscellaneous ancillary products maintained in inventory, such as labels and other non-medication products.

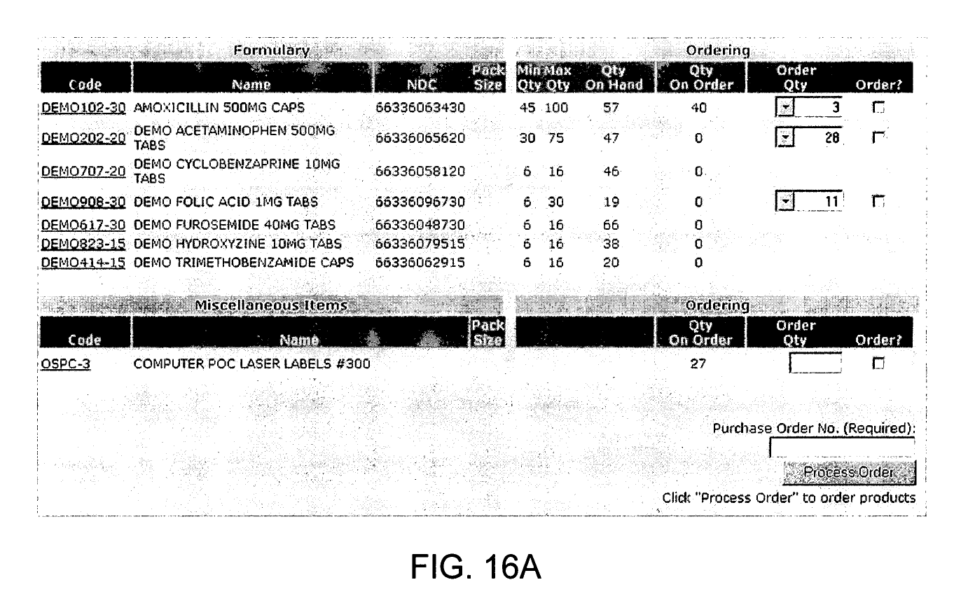

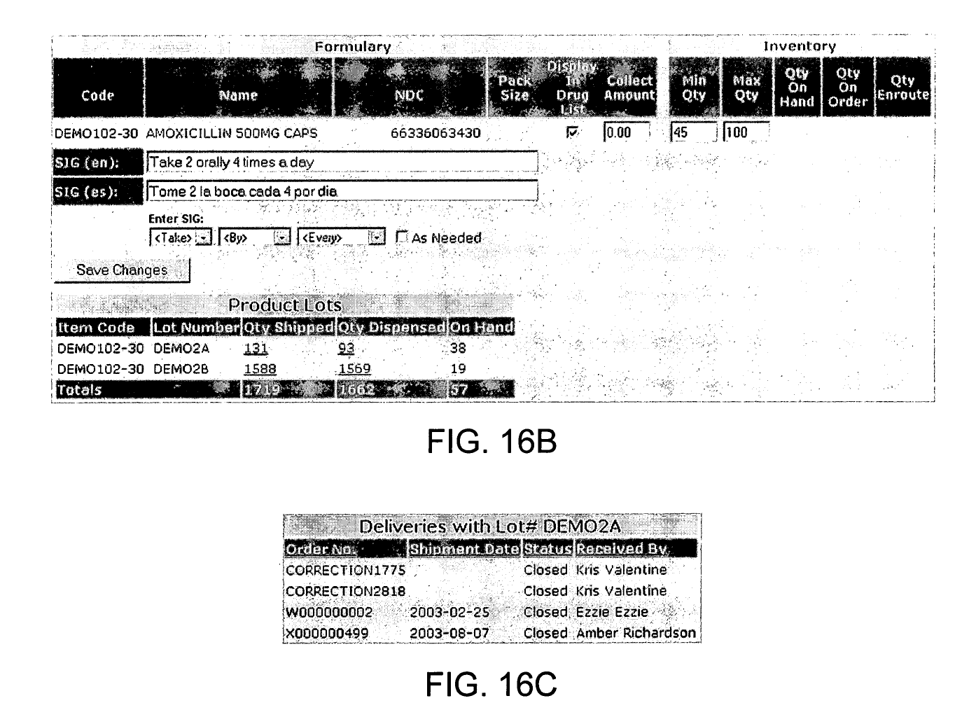

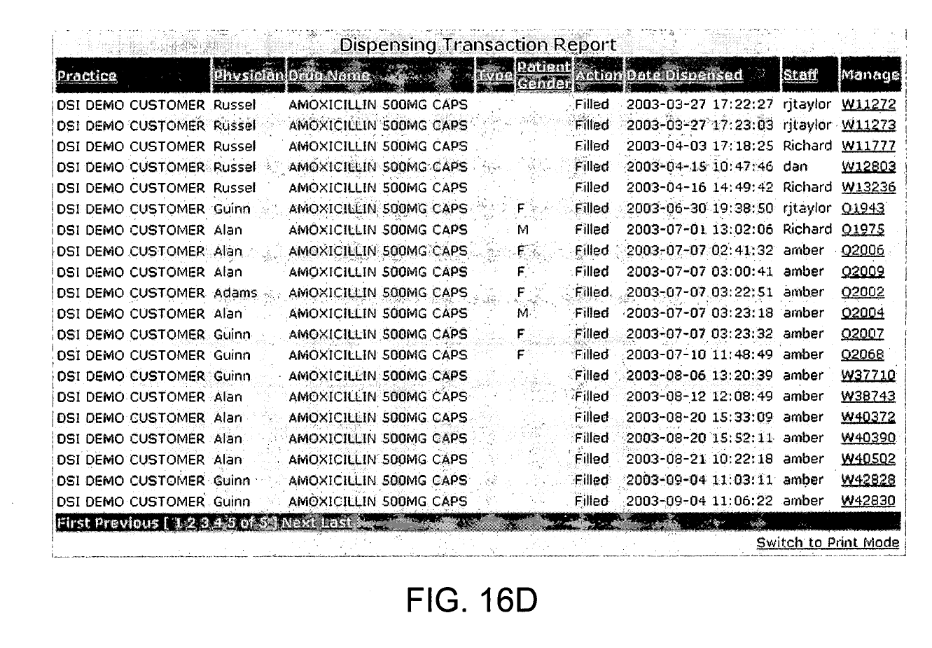

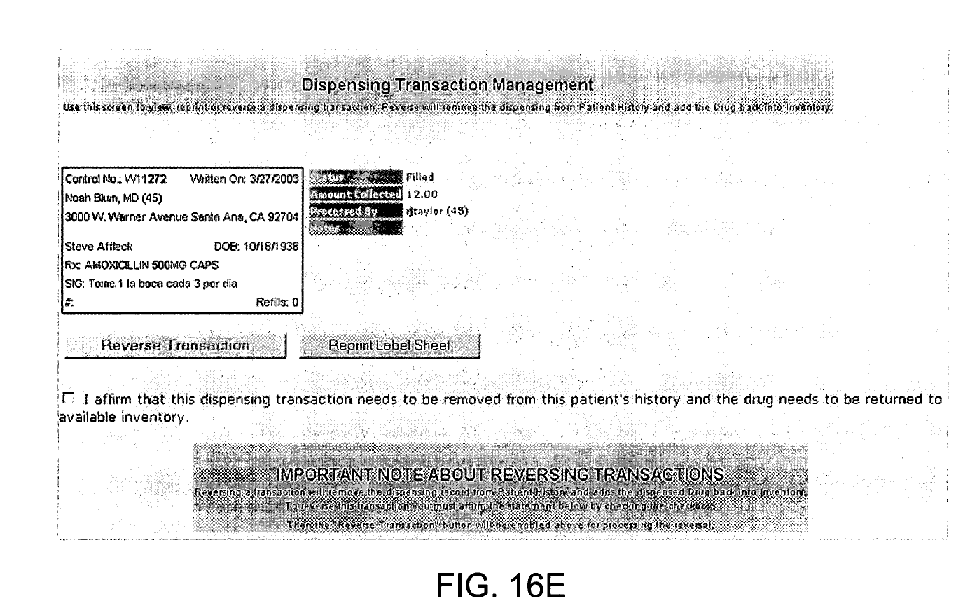

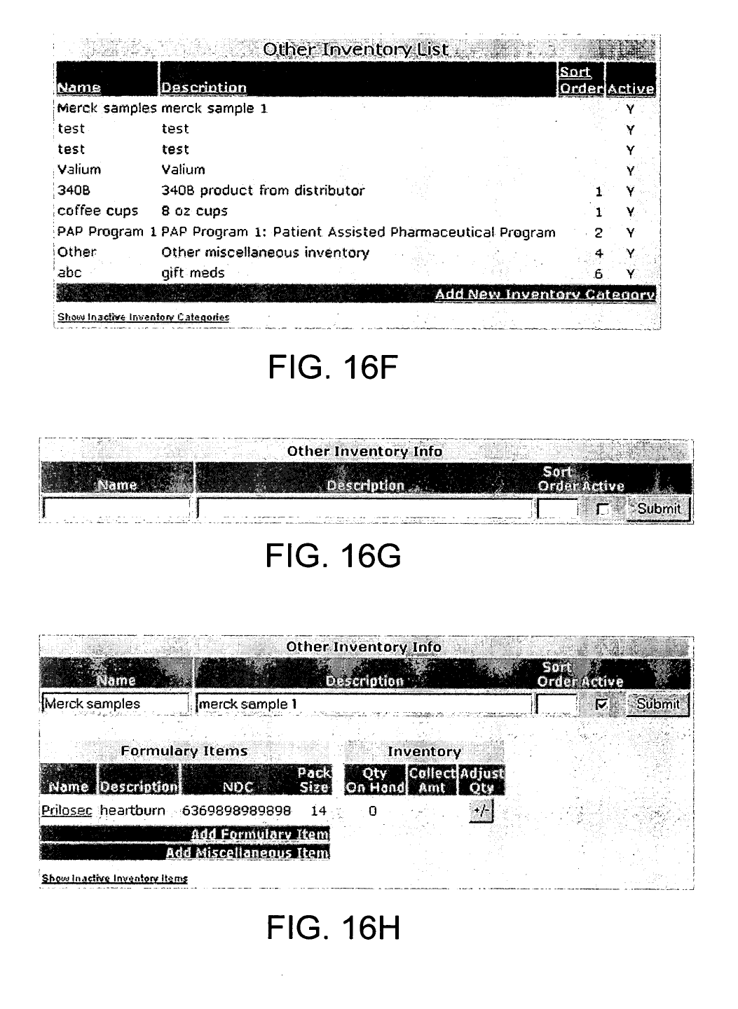

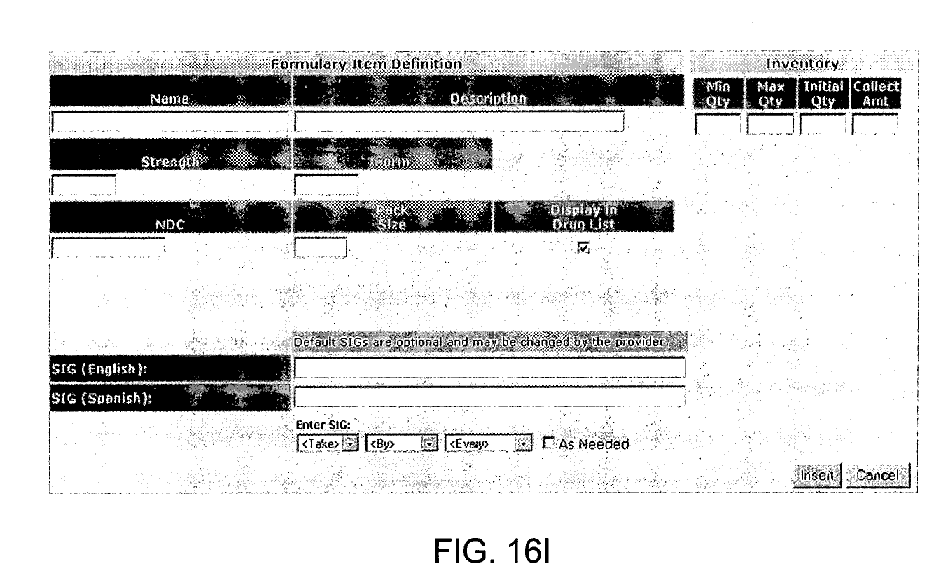

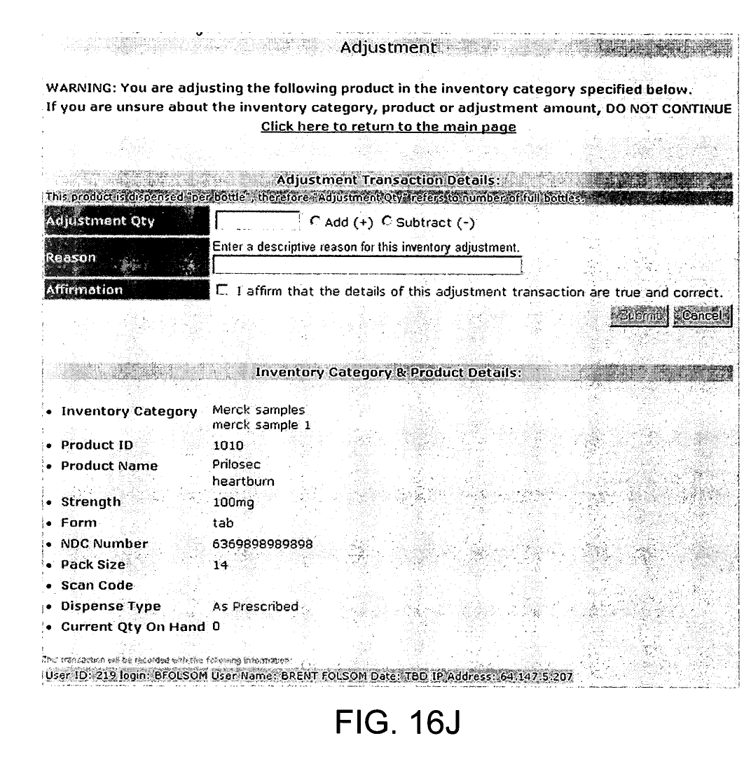

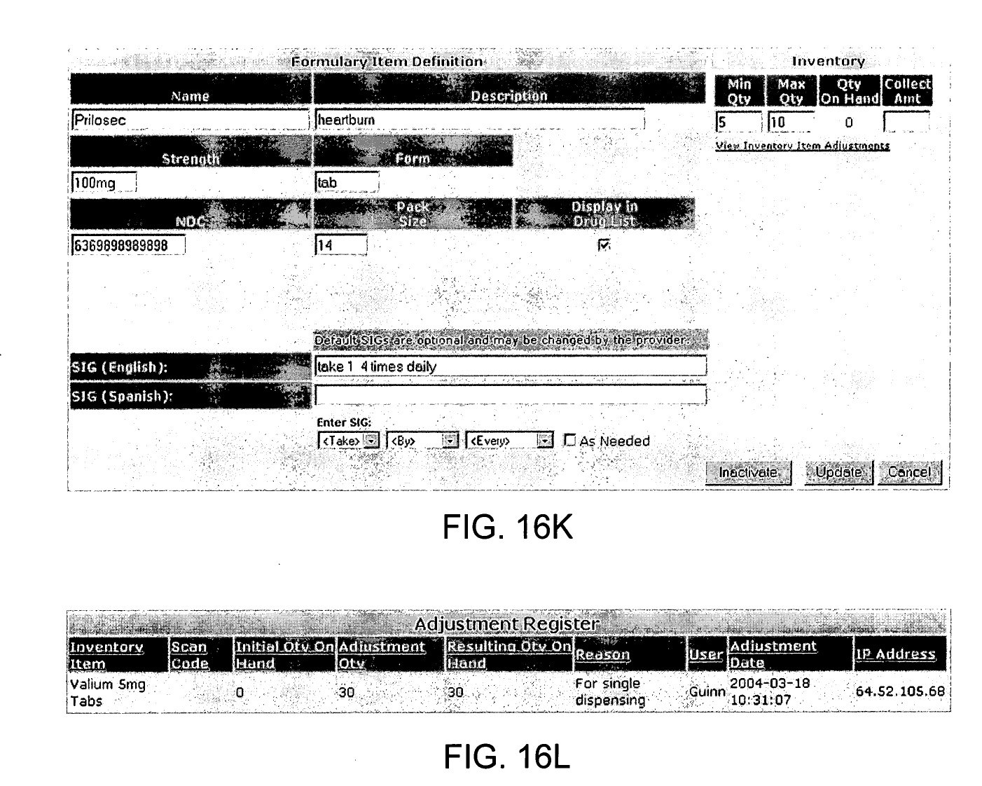

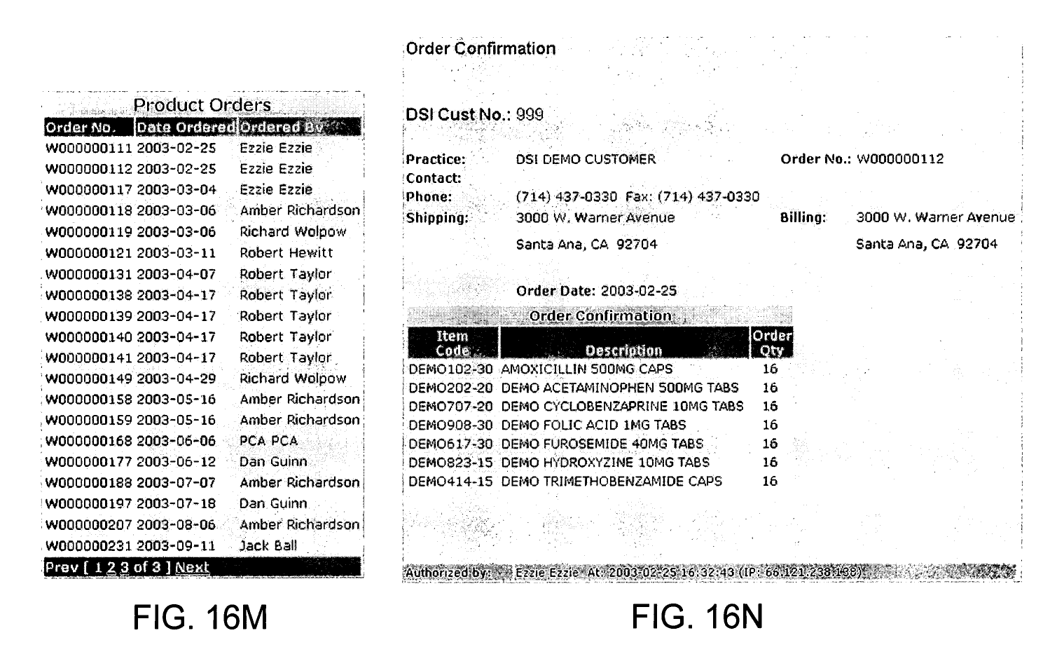

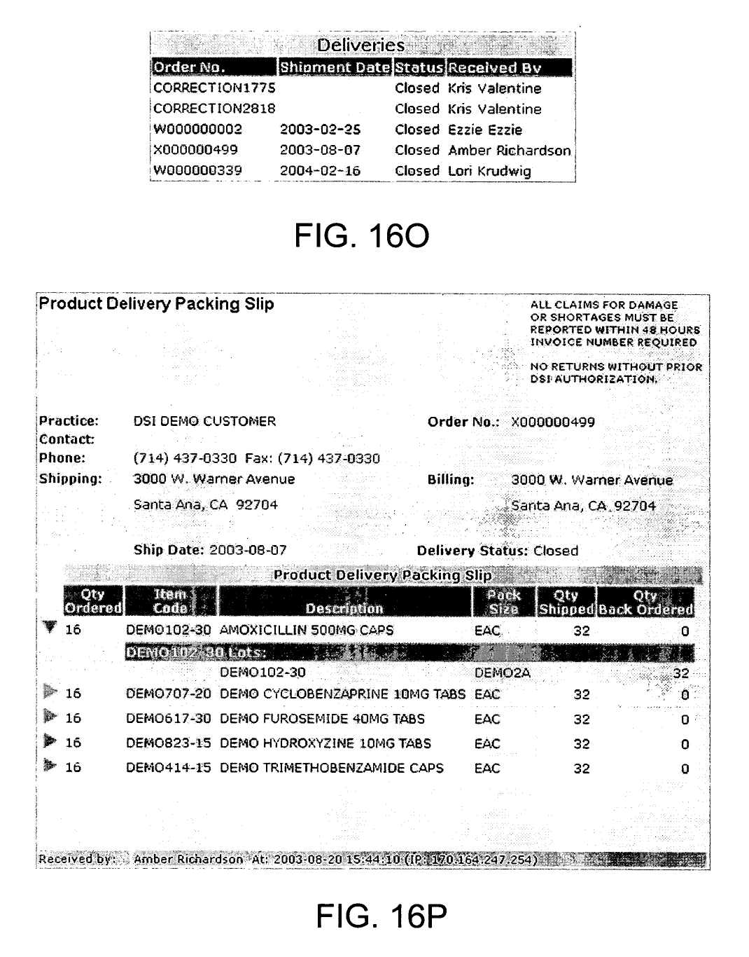

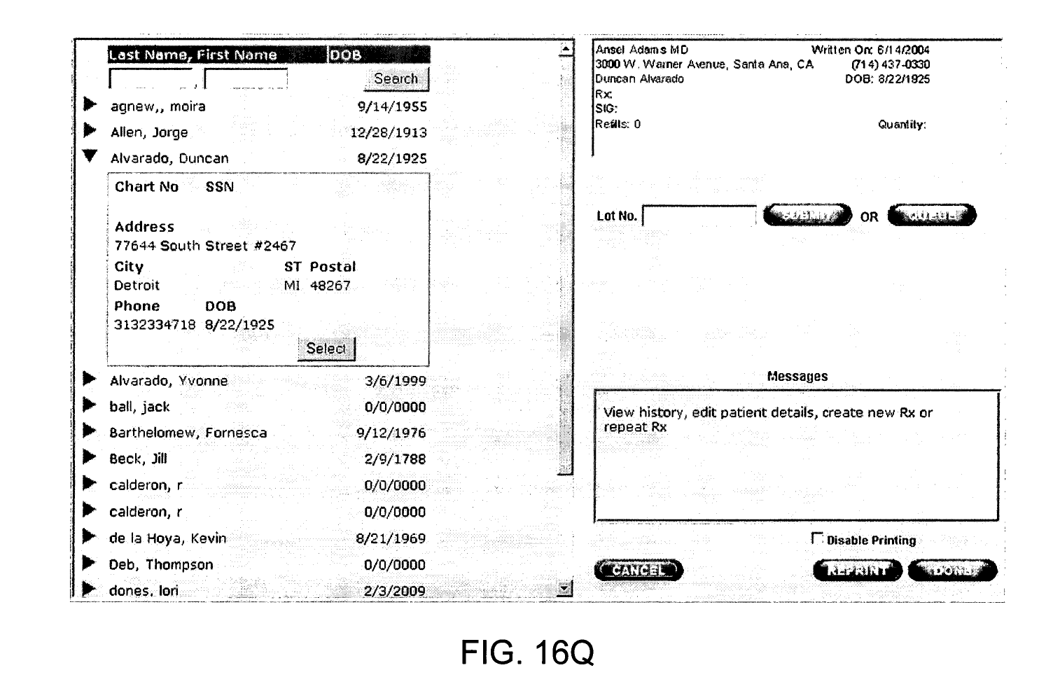

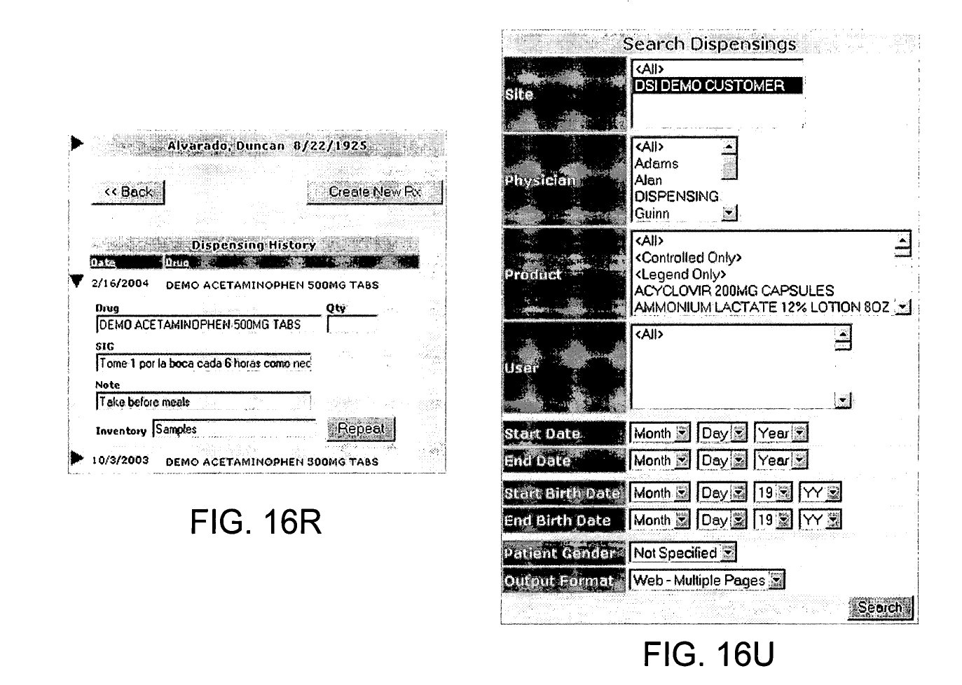

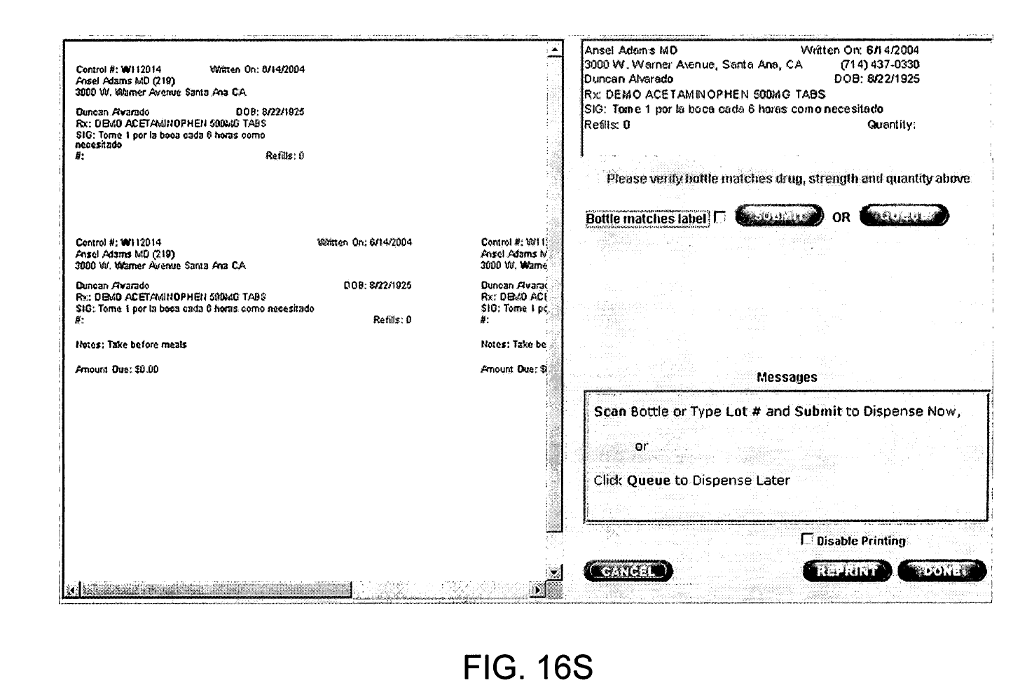

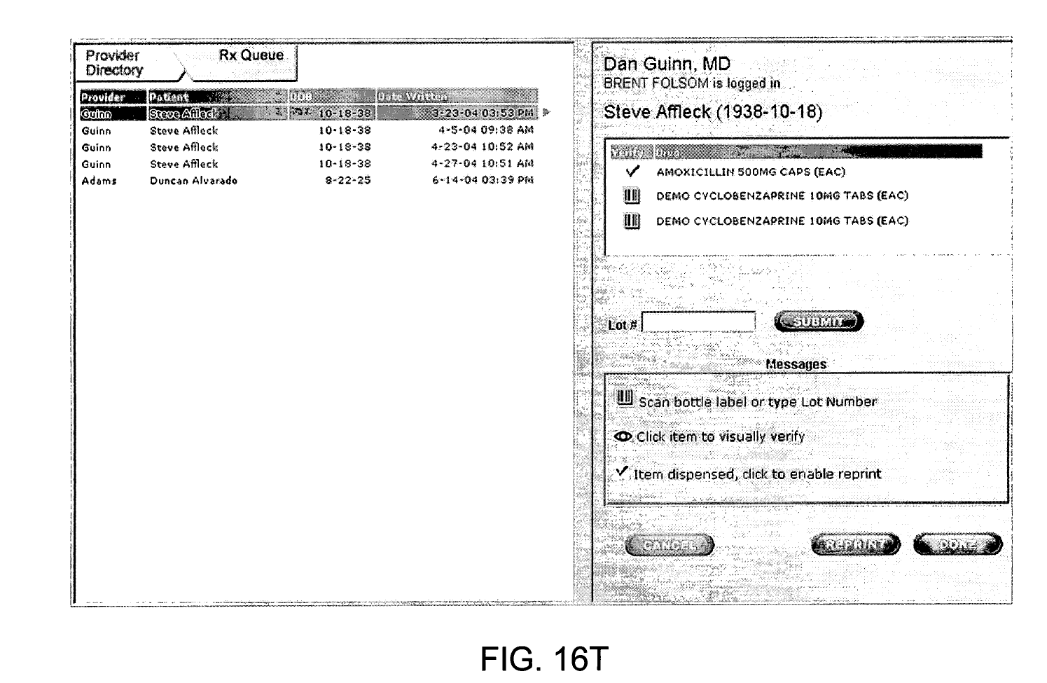

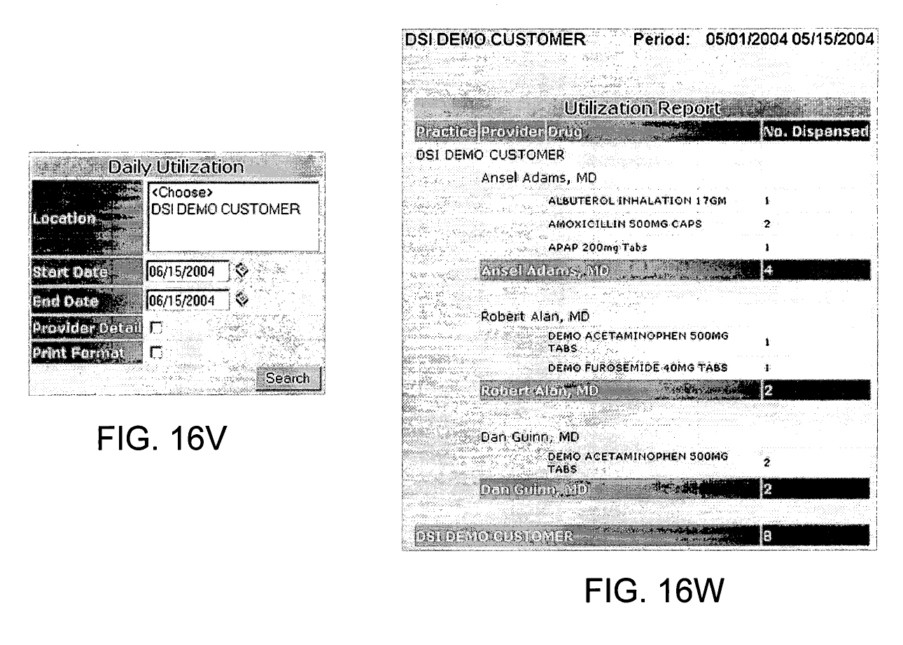

FIG. 16A illustrates an exemplary formulary list returned in step 415. As set forth in FIG. 16A, each formulary item can be listed with an associated product code, name, NDC, pack size, minimum quantity, maximum quantity, quantity on hand (i.e. presently in inventory), quantity on order, quantity to be ordered, and a reorder alert check box indicating whether an order should be placed. As illustrated, an additional list of miscellaneous items to be maintained in inventory can also be provided with an associated product code, name, pack size, quantity on order, quantity to be ordered, and a reorder alert check box indicating whether an order should be placed.

When the quantity of a product on hand is at or below the minimum quantity value, the reorder alert check box associated with the product will be checked, and the appropriate reorder quantity is displayed in the Order Qty window. As illustrated in FIG. 16A, orders for additional quantities of items appearing in the list can be placed from the formulary list screen by selecting an order quantity, checking the order box, entering a purchase order number, and selecting the “Process Order” link. In response, server 170 can process the order and store an associated record of the order.

At step 420, user 150 can select a product code associated with any of the items provided in the formulary list. In response, server 170 returns detailed information for the selected item, as well as product lot information associated with the item (step 425). FIG. 16B illustrates an exemplary screen shot of detailed information returned by server 170 for the drug “AMOXICILLIN 500MG CAPS” selected from the formulary list of FIG. 16A. As set forth in FIG. 16B, the option “Display in Drug List” can be selected for various inventory items that are tracked by system 100. If the option is checked, then the item will be made available for dispensing, as further described herein. If such option is not checked, then the item can still be ordered and tracked, but will not be made available for dispensing. As further illustrated in FIG. 16B, a collection amount can be specified for the selected drug, identifying a dollar amount to be charged when the drug is dispensed. In various embodiments, collection amounts can vary from patient to patient, and can be set based on patient-specific health plans, a patient's financial ability to pay, and/or other factors. Minimum and maximum inventory amounts can also be set, as well as a default SIG in English and/or a patient-specific language (i.e. Spanish). If user 150 desires to edit the detailed information (step 430), then the user 150 can modify the information as desired (step 435) and thereafter click on the “Save Changes” button. In response, the server 170 will update the information in data records 190 in real time (step 440) and return an updated formulary list (step 415).

User 150 can also choose to view specific information pertaining to the product lots associated with the selected item. By clicking on the “Qty Shipped” link (step 445) in FIG. 16B, a list of deliveries for the selected lot is returned by server 170 (step 450). FIG. 16C illustrates an exemplary screen shot of such a list of deliveries for lot number “DEMO2A.” It will be appreciated that such a delivery list allows user 150 to verify the quantity of drugs delivered to office 105, the shipping status, and ship dates.

If user 150 clicks on the “Qty Dispensed” link (step 445) in FIG. 16B, a lot number transaction report is returned by server 170 (step 450). FIG. 16D illustrates an exemplary screen shot of such a lot number transaction report for lot number “DEMO2A.” It will be appreciated that such a report list allows user 150 to view the dispensing history, lot number, including physician and staff who initiated the dispensing, patient gender, and date of dispensing associated with the selected lot. In various embodiments, a screen shot of the drug label sheet can be returned by server 170 for viewing by user 170 in response to the user 150 clicking on the name of the drug and/or the control number in the far right column of the transaction report. FIG. 16E illustrates an exemplary screen shot of such a drug label sheet. As will be apparent from FIG. 16E, the particular dispensing transaction selected from the transaction report can also be reversed if necessary.

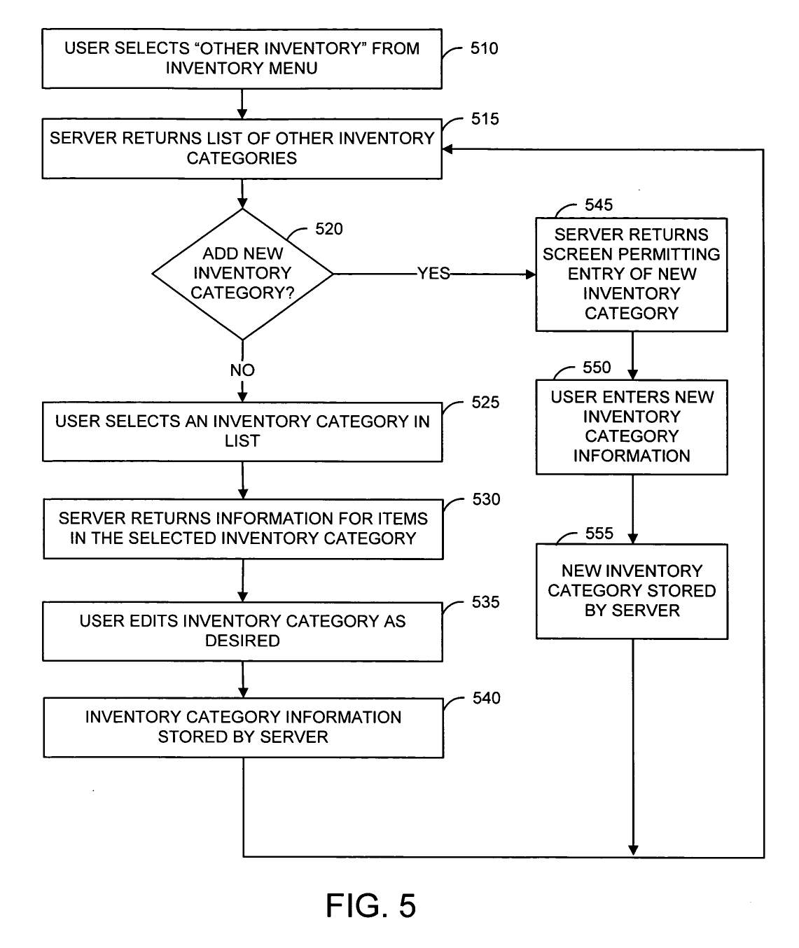

FIG. 5 is a flowchart describing a process for customizing inventory categories in accordance with an embodiment of the present invention. At step 510, a user 150 having administrative privileges selects the “Other Inventory” option from the Inventory menu of menu bar 310 of FIG. 3. In response, server 170 returns a list of other inventory categories for items to be included in the inventory of office 105 (step 515).

FIG. 16F illustrates an exemplary list of other inventory categories returned by server 170 in step 515. As set forth in FIG. 16F, each inventory category can be listed with an associated name, description, sort order, and an indication as to whether items in the inventory category are available for dispensing. The listed inventory categories can also be sorted by column in response to a user's 150 clicking on any of the column headings.

If the user 150 desires to add a new inventory category (step 520), the user may select the “Add New Inventory Category” link displayed with the inventory category list. In response, server 170 returns a screen permitting entry of the new inventory category (step 545). FIG. 16G illustrates an exemplary screen permitting entry of information for the new inventory category identifying the category name, category description, sort order of the new category in relation to other categories, and active status. Upon entry of the new category information (step 550), the user 150 can select the “Submit” button illustrated in FIG. 16G. In various embodiments, such new category information can include information to be provided on a patient education/drug label which is tagged and associated with the category. A user-accessible tutorial can also be provided in step 550 to facilitate the entry of new category information. In response to step 550, the server 170 will store the new inventory category information in data records 190 in real time (step 555) and return an updated inventory category list (step 515).

If the user 150 chooses not to add any further inventory categories (step 520), then the user may choose to select one of the inventory categories provided in the inventory category list (step 525). In response, server 170 returns information regarding the items contained in the selected inventory category (step 530). FIG. 16H illustrates an exemplary screen providing information for the inventory category “Merck samples” selected from the inventory category list of FIG. 16F. As set forth in FIG. 16H, the inventory category “Merck samples” includes a formulary identified as “Prilosec.”

While viewing the screen of FIG. 16H, the user 150 can edit the inventory category information as desired (step 535) and select the “Submit” button. In response, the server 170 will store the edited inventory category information in data records 190 in real time (step 540) and return an updated inventory category list (step 515).

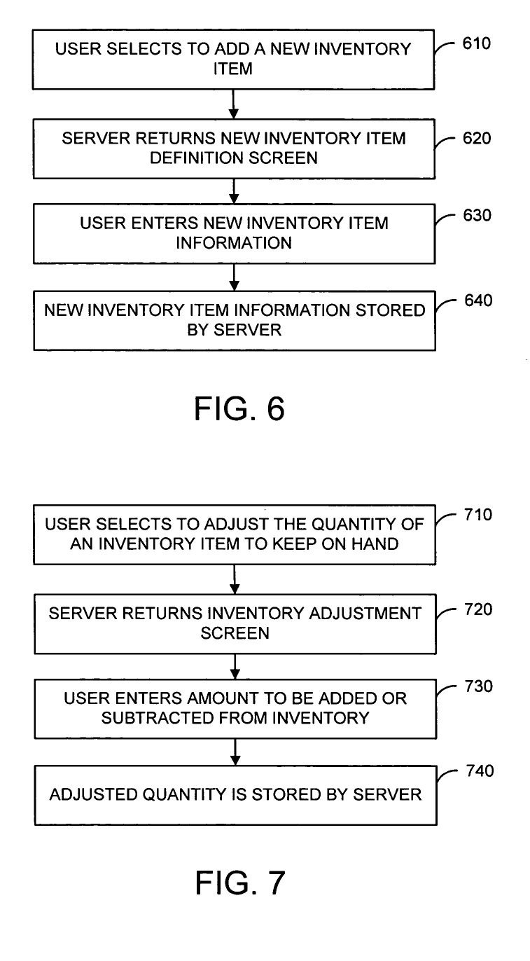

FIG. 6 is a flowchart describing a process for adding an inventory item to an inventory category in accordance with an embodiment of the present invention. When server 170 returns information regarding the items contained in a selected inventory category (for example, see FIG. 16H and step 530 of FIG. 5 previously discussed), a user 150 may choose to add an additional item to the selected inventory category (step 610). As illustrated in FIG. 16H, the user 150 may choose to select “Add Formulary Item” or “Add Miscellaneous Item.” In response to the user's 150 selection, server 170 returns a new inventory item definition screen (step 620). FIG. 16I illustrates an exemplary new inventory item definition screen.

At step 630, the user 150 can enter information for the new inventory item using various fields provided by the new inventory item definition screen. As illustrated in FIG. 161, information for each new inventory item can include: name, description, strength, form, NDC, pack size, collection amount, and whether the item should be available for dispensing. In addition, a default SIG, minimum inventory amount, and maximum inventory amount can also be specified for each new inventory item. Upon entry of the new inventory item information, the user 150 can select the “Insert” button illustrated in FIG. 16I.

Various actions can be taken in step 630, depending on whether a barcode is associated with the new inventory item. In one embodiment, if the new inventory item has an associated barcode, then the barcode can be scanned by the user 150, and the user 150 can enter the initial quantity of the item. In response, the server 170 can retrieve the new inventory item information from an appropriate database in communication with server 170. It will be appreciated that in such an embodiment, the data records 190 associated with the new inventory item can be automatically populated, facilitating the tracking of the new inventory item. In another embodiment, the new inventory information can be manually entered by the user if the new inventory item information is not available from a database in communication with server 170. In yet another embodiment, a barcode can be automatically generated for the new inventory item and associated with the new inventory item information entered by the user 150.

In response to step 630, the server 170 will store the new inventory item information in data records 190 in real time (step 640) and return an updated list of items contained in the selected inventory category (step 530 of FIG. 5).

FIG. 7 is a flowchart describing a process for adjusting inventory quantity in accordance with an embodiment of the present invention. When server 170 returns information regarding the items contained in a selected inventory category (for example, see FIG. 16H and step 530 of FIG. 5 previously discussed), a user 150 may choose to adjust the quantity of a particular item in the selected inventory category to be kept on hand in the inventory 140 of office 105 (step 710). As illustrated in FIG. 16H, the user 150 may select the button labeled as “+/−” in the “Adjust Qty” column. In response to the user's 150 selection, server 170 returns an inventory adjustment screen (step 720). FIG. 16J illustrates an exemplary inventory adjustment screen with various user-selectable fields and inventory category and product details displayed below the fields.

At step 730, the user 150 can enter the amount to be added or subtracted to the current quantity of the item to be kept on hand and a reason for the adjustment. Upon entry of the quantity information, the user can be required to affirm the accuracy of the adjustment transaction by selecting an affirmation check box as illustrated in FIG. 16J. Thereafter, the user 150 can select the “Submit” button illustrated in FIG. 16J to execute an adjustment transaction. In response, the server 170 will store the adjusted quantity information in data records 190 in real time (step 740) and return an updated list of items contained in the selected inventory category (step 530 of FIG. 5). In various embodiments, the user's 150 user ID, login, user name, date, and IP address can be stored with a record of the adjustment transaction.

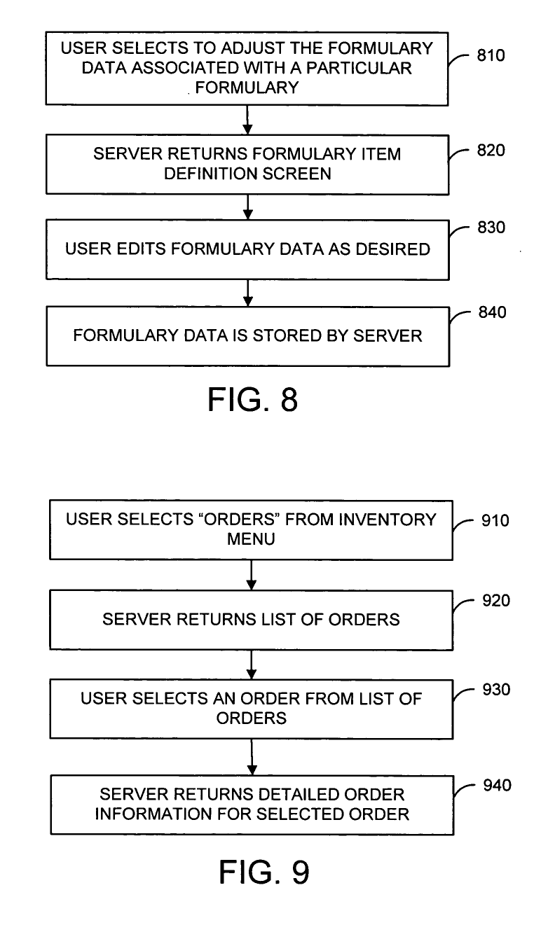

FIG. 8 is a flowchart describing a process for modifying inventory formulary data in accordance with an embodiment of the present invention. When server 170 returns information regarding the items contained in a selected inventory category (for example, see FIG. 16H and step 530 of FIG. 5 previously discussed), a user 150 may choose to adjust the formulary data associated with a particular formulary provided in the list (step 810). In various embodiments, a user 150 may initiate such action by clicking on the name and/or code associated with a particular formulary in the list. In response to the user's 150 selection, server 170 returns a formulary item definition screen (step 820). FIG. 16K illustrates an exemplary formulary item definition screen.

At step 830, the user 150 can edit information for the selected formulary item using various fields provided by the formulary item definition screen. As illustrated in FIG. 16K, the formulary information edited in step 830 can include: name, description, strength, form, NDC, pack size, collection amount, and whether the item should be displayed as being available for dispensing. In addition, a default SIG, minimum inventory amount, maximum inventory amount, and quantity to keep on hand can also be specified for the formulary. Upon editing the formulary item information, the user 150 can select the “Update” button illustrated in FIG. 16K. In response, the server 170 will store the updated formulary information in data records 190 in real time (step 840) and return an updated list of items contained in the selected inventory category (step 530 of FIG. 5). In addition, by selecting the “View Inventory Item Adjustments” link illustrated in FIG. 16K, the user 150 can view an adjustment register that provides a list of records detailing adjustment transactions made to formulary. FIG. 16L illustrates an exemplary adjustment register which identifies various fields associated with an adjustment transactions. It will be appreciated that the inclusion of such fields in the record of the adjustment transaction permits authorized users to identify the user responsible for the adjustment, adjustment date, IP address of the computer 120 used to make the adjustment, reason for the adjustment, and other information set forth in FIG. 16L.

In another aspect of the present invention, system 100 can permit users 150 to view records of outstanding and past orders of inventory items, and track orders by user ID and IP address. FIG. 9 is a flowchart describing a process for viewing order information in accordance with an embodiment of the present invention. At step 910, a user 150 selects the “Orders” option from the Inventory menu of menu bar 310 of FIG. 3. In response, server 170 returns a list of past and outstanding orders of inventory items (step 920). FIG. 16M illustrates an exemplary list of orders returned by server 170 in step 920. As set forth in FIG. 16M, each product order can be listed with the order number, date of the order, and the name of the user 150 placing the order. The listed orders can also be sorted by column in response to a user's 150 clicking on any of the column headings.

If a user desires to view further details regarding a particular order in the list, the user can select the order by clicking on the order (step 930). In response, server 170 returns detailed order information regarding the selected order (step 940). FIG. 16N illustrates an exemplary screen shot of detailed information returned for order no. “W000000112” selected from the list of orders displayed in FIG. 16M. As set forth in FIG. 16N, each order can be tracked by user ID, IP address, and date/time stamp. Such information can be stored with the record of the order maintained by server 170.

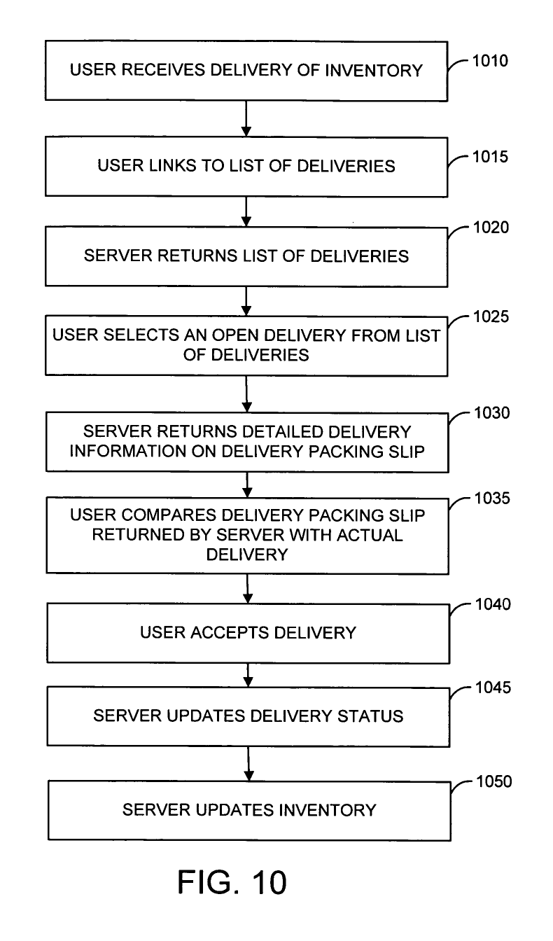

In another aspect of the present invention, system 100 can automatically populate inventory records upon acceptance of deliveries of inventory items. FIG. 10 is a flowchart describing a process for accepting delivery of inventory in accordance with an embodiment of the present invention. It will be appreciated that such deliveries can include any type of inventory associated with a medical practice described herein, regardless of the supplier. When a delivery of inventory items is in queue, server 170 can provide a delivery notification to user 150. Such notification can be provided by a blinking status alert light in the menu bar 310 of the main screen illustrated in FIG. 3, a “Delivery” link displayed next to the status alert light, and/or a “Delivery” link displayed in the status window 350 of the main screen.

At step 1010, user 150 receives a delivery of inventory items at office 105. Upon receiving the delivery, the user 150 accesses system 100 through physician computer 120 and links to a list of current deliveries (step 1015). In various embodiments, such linking action can be performed by the user 150 clicking on one or more of the delivery notifications provided by server 170. In response, server 170 returns a list of deliveries (step 1020). FIG. 160, discussed further below, illustrates an exemplary list of deliveries.

At step 1025, the user 150 selects an open delivery from the list of deliveries corresponding to the delivery received in step 1010. Server 170 then displays a delivery packing slip corresponding to the delivery selected by the user 150 (step 1030). FIG. 16P, discussed further below, illustrates an exemplary delivery packing slip.

At step 1035, user 150 compares the delivery packing slip returned by server 170 with the actual content of the delivery previously received in step 1010. If a match is found, then user 150 can formally accept the delivery by clicking on an “Accept” link displayed in the user interface of physician computer 120 (step 1040). An additional reminder dialog box can also be provided by system 100 to enable user 150 to further confirm that the content of the delivery is correct. In various embodiments, a user 150 can manually enter a lot number and bottle count associated with the delivery in step 1040. It will be appreciated that by associating the lot number with the delivery, inventory items can be tracked by lot number. In various embodiments, system 100 can interface with the computer systems of an unlimited number of suppliers of medical supplies. It will be appreciated that, as a result of such interfacing, lot numbers associated with deliveries can be electronically provided to system 100, allowing for the tracking of lot numbers associated with inventory items and deliveries, regardless of the supplier providing the delivery. In response to the user's 150 acceptance of the delivery in step 1040, server 170 updates data records 190 with the delivery status of the order (step 1045) and the inventory items contained in the order (step 1050).

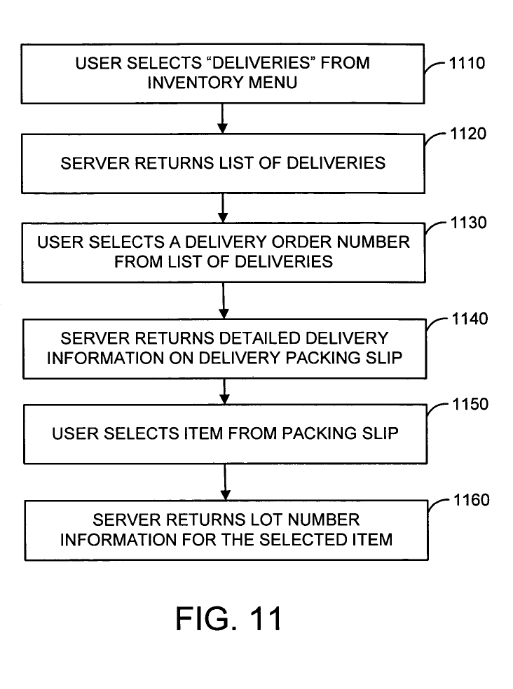

In another aspect of the present invention, system 100 can enable users 150 to view expected, incoming, and past deliveries of inventory items, and track such deliveries by user ID and IP address. FIG. 11 is a flowchart describing a process for viewing delivery information in accordance with an embodiment of the present invention.

At step 1110, a user 150 selects the “Deliveries” option from the Inventory menu of menu bar 310 of FIG. 3. In response, server 170 returns a list of deliveries stored in data records 190 (step 1120). FIG. 160 illustrates an exemplary list of deliveries returned by server 170 in step 1120. As set forth in FIG. 160, each delivery can be listed with the order number, shipment date, status, and the name of the user 150 receiving the delivery. The listed deliveries can also be sorted by column in response to a user's 150 clicking on any of the column headings.

If a user 150 desires to view further details regarding a particular delivery in the list, the user can select the delivery by clicking on its listing (step 1130). In response, server 170 returns a detailed delivery packing slip for the selected delivery (step 1140). FIG. 16P illustrates an exemplary delivery packing slip returned for order no. “X000000499” selected from the list of deliveries displayed in FIG. 160. As set forth in FIG. 16P, each delivery can be tracked by user ID, IP address, and date/time stamp. Such information can be stored with the record of the delivery maintained by server 170.

If a user 150 desires to view further information for the selected delivery, the user 150 can select an individual item listed on the delivery packing slip (step 1150). In response, server 170 returns lot number information for the selected item (step 1160). In the exemplary screen shot provided in FIG. 16P, lot information for the selected item “AMOXICILLIN 500MG CAPS” is provided. It will be appreciated that by storing lot information in data records 190, such information can be tracked and associated with the deliveries handled by system 100.

In another aspect of the present invention, system 100 can enable qualified users 150 to dispense medication to patients from office 105. System 100 can also be implemented to update inventory records in real time in response to such dispensings. Medication can be dispensed as a single script or multiple scripts to one patient. In the case of multiple scripts, an authorized user 150 can optionally write all of the scripts, store them in a prescription queue, and then finish processing the scripts by verifying and labeling at a later time. It will be appreciated that such a process can permit the user 150 to collect all of the medication to be dispensed for a one patient from inventory, bring the medication to the computer, and verify the medication as a batch.

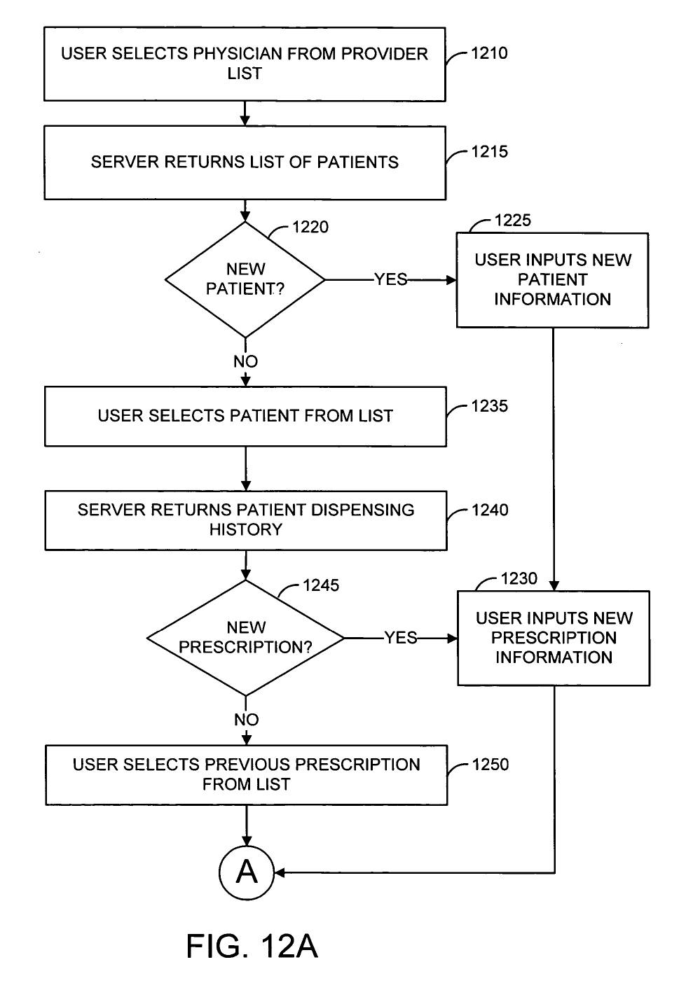

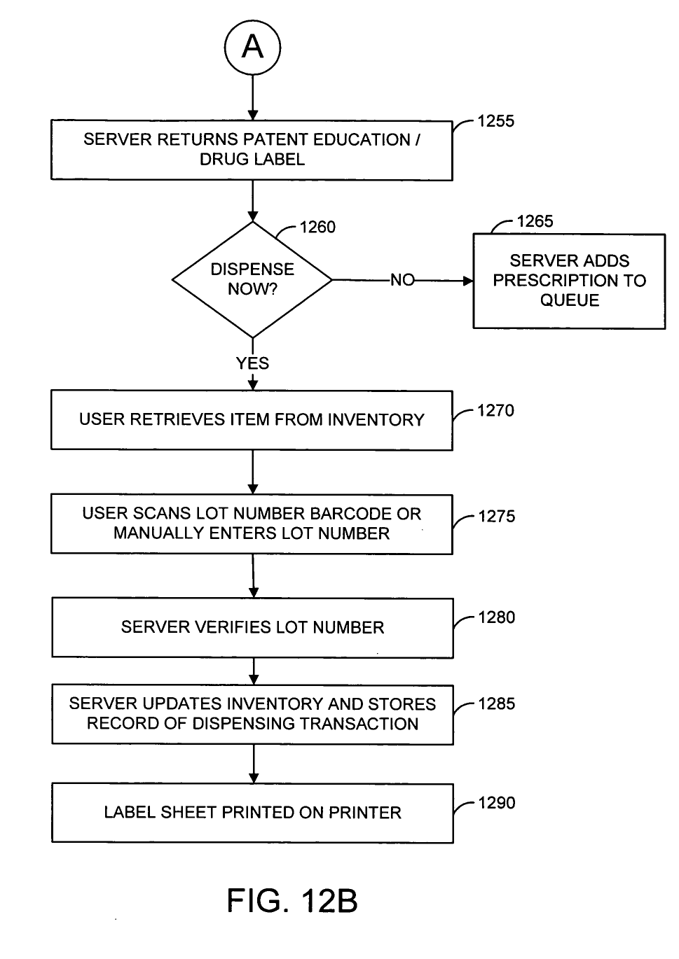

FIGS. 12A and 12B are flowcharts describing a process for dispensing formulary from inventory in accordance with an embodiment of the present invention. At step 1210, a user 150 selects a physician to be responsible the dispensing transaction. For example, from the main screen illustrated in FIG. 3, a user 150 can select a provider from those listed under the provider directory tab 320. In response to the user's 150 selection of a provider, server 170 returns a list of patients associated with the selected provider (step 1215). FIG. 16Q illustrates an exemplary patient list and related information returned by server 170 in step 1215. If medication is to be dispensed to a new patient (step 1220), then the user 150 can select an “Add” link. In response, the user 150 can be presented with a screen for entering the new patient information which is subsequently stored by server 170 in data records 190 (step 1225).

If medication is to be dispensed to a preexisting patient, then user 150 can select the patient from the patient list returned by server 170 (step 1235). As set forth in FIG. 16Q, the patient list can be displayed alphabetically and can be searched by last name and/or first name. As further illustrated in FIG. 16Q, additional patient information can be displayed in the patient list by selecting the triangle graphic appearing to the left of each patient in the list. In response to the user's 150 selection of a patient, server 170 returns a list of the selected patient's dispensing history in reverse chronological order (step 1240). FIG. 16R illustrates an exemplary screen shot of the dispensing history for a selected patient returned by server 170 in step 1240.

If a new prescription is to be provided (step 1245), then the user 150 can select the “Create New Rx” link illustrated in FIG. 16R. In response, the user 150 can be presented with a screen for selecting medication from an inventory category and entering the new prescription information, which is subsequently stored by server 170 in data records 190 (step 1230).

If a previous prescription is to be repeated (step 1245), then the user 150 selects one of the prescriptions from the patient's dispensing history (step 1250). In the example illustrated in FIG. 16R, a previous prescription for “ACETAMINOPHEN 500MG TABS” has been selected. In response to the selection, server 170 displays further prescription information, including the drug, quantity, SIG, notes, and inventory category of the drug. To proceed with the repeat prescription, the user 150 can select a repeat “Repeat” link as illustrated in FIG. 16R.

In response to steps 1230 and 1250, server 170 populates and returns a patient education/drug label in step 1255. FIG. 16S illustrates an exemplary screen returned by server 170 in step 1255. As illustrated in FIG. 16S, a patient education/drug label sheet can be displayed in the left hand window pane of the screen, and dispensing options can be displayed in the right hand side of the screen.

If the user 150 desires to dispense the selected prescription at a later time (step 1260), then the user 150 can request that the prescription be added to a prescription queue (step 1265). It will be appreciated that any desired number of prescriptions can be selected and added to the queue, thereby enabling user 150 to dispense a desired number of prescriptions to a patient at one time. Referring to the example of FIG. 16S, a user 150 can select the link “Queue” in order to add the selected prescription to the queue. In response, the server 170 adds the prescription to the queue and returns a message to the user 150 indicating that the subscription has been successfully added to the queue. It will be appreciated that additional prescriptions can be added to the queue by repeating appropriate steps of FIGS. 12A and 12B.

If the user 150 desires to dispense the selected prescription (step 1260), the additional steps of FIG. 12B can be performed. At step 1270, the user 150 retrieves the medication to be dispensed from inventory 140. The user 150 then scans a barcode on the bottle of the retrieved medication which identifies the lot number of the medication (step 1275). As a result, the lot number of the medication to be dispensed is captured by system 100. Alternatively, the lot number can be manually entered by user 150. In response, server 170 compares the lot number received in step 1275 with the lot numbers associated with inventory of the system 100 (step 1280). If no match is found, a red warning message can be provided (i.e. a red warning message can be displayed in the “Messages” window of FIG. 16Q), requiring the user 150 to rescan the barcode. In various embodiments, such a red warning message can be displayed if the user 150 selects the incorrect item and/or if data records 190 indicate that the lot number is not in the inventory 140 of office 105. However, if a successful match is found, then the dispensing transaction will be completed. In various embodiments, a green message can be provided (i.e. a green message can be displayed in the “Messages” window of FIG. 16Q) indicating the success.

Alternatively, if the medication to be dispensed does not have an associated barcode (for example, if the medication is not in the form of repackaged drugs 145), then user 150 can be required to affirmatively verify to system 100 that the retrieved medication matches the drug, strength, and quantity of the prescription. It will be appreciated that such actions can be taken in lieu of steps 1275 and 1280.

At step 1285, inventory records are updated in real time to reflect the dispensing of medication, and a record of the dispensing transaction is stored. At step 1290, a patient education/drug label sheet can be printed on printer 110 and then subsequently applied to the bottle by user 150. In various embodiments, the collection amount associated with the medication can be printed on a receipt portion of the label sheet.

As previously discussed, various embodiments of system 100 can permit prescriptions to be stored in a prescription queue and dispensed as desired. In various embodiments, system 100 can notify a user 150 of the presence of items in the prescription queue by causing the status alert light to blink, displaying tab 340 in red, displaying the number of items in the queue in the status window 350, and/or displaying a message in the message window 330.

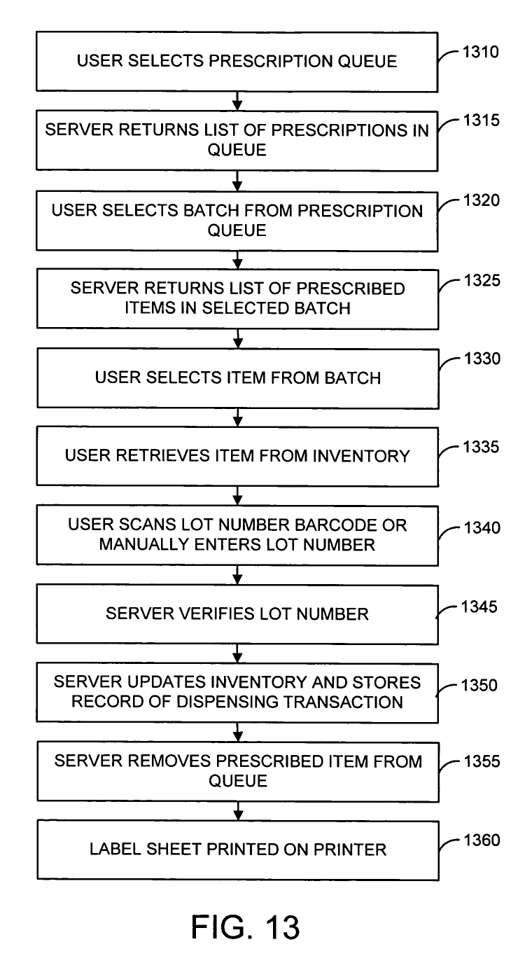

FIG. 13 is a flowchart describing a process for dispensing formulary from a prescription queue in accordance with an embodiment of the present invention. At step 1310, the user 150 selects an appropriate link to access the prescription queue. In one embodiment, this step can be achieved by selecting tab 340 of FIG. 3. In response, server 170 returns a list of batches currently stored in the prescription queue (step 1315). The user 150 can select a patient-specific batch of prescriptions to be dispensed (step 1320). In response, server 170 returns a list of prescriptions included in the selected batch (step 1325). FIG. 16T illustrates an exemplary prescription queue (left hand pane returned by server 170 in step 1315) and a list of prescribed items associated with the selected batch (right hand pane returned by server 170 in step 1325). As illustrated in the “Messages” pane of FIG. 16T, a barcode verification method or visual verification method can be associated with each prescribed item.

In order to dispense items for the selected batch, the user 150 selects one or more of the prescribed items associated with the selected batch (step 1330). At step 1335, the user 150 retrieves the selected item from inventory 140. The user 150 then scans a barcode on the bottle of the retrieved medication which identifies the lot number of the medication (step 1340). As a result, the lot number of the medication to be dispensed is captured by system 100. Alternatively, the lot number can be manually entered by user 150. In response, server 170 compares the lot number received in step 1340 with the lot numbers associated with inventory of the system 100 (step 1345). If no match is found, a red warning message can be provided (i.e. a red warning message can be displayed in the “Messages” window of FIG. 16Q), requiring the user 150 to rescan the barcode. In various embodiments, such a red warning message can be displayed if the user 150 selects the incorrect item and/or if data records 190 indicate that the lot number is not in the inventory 140 of office 105. However, if a successful match is found, then the dispensing transaction will be completed. In various embodiments, a green message can be provided (i.e. a green message can be displayed in the “Messages” window of FIG. 16Q) indicating the success.

Alternatively, if the medication to be dispensed does not have an associated barcode (for example, if the medication is not in the form of repackaged drugs 145), then user 150 can be required to affirmatively verify to system 100 that the retrieved medication matches the item in the batch. It will be appreciated that such actions can be taken in lieu of steps 1340 and 1345.

At step 1350, inventory records are updated to reflect the dispensing of medication, and a record of the dispensing transaction is stored. At step 1355, server 170 removes the prescribed item from the prescription queue. A patient education/drug label sheet can be printed on printer 110 and then subsequently applied to the bottle by user 150 (step 1360).

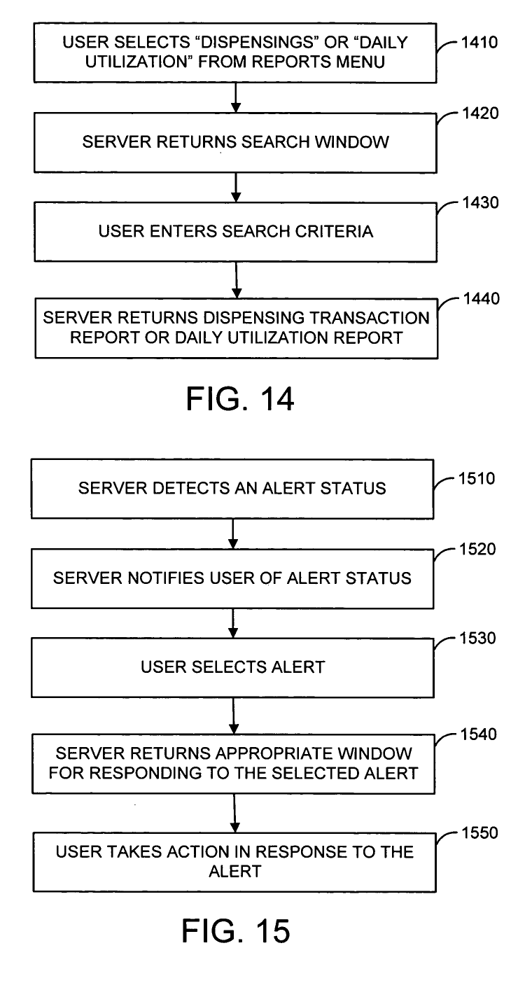

In another aspect of the present invention, various embodiments of system 100 can permit a user 150 to view reports generated by server 170 regarding dispensing transactions and/or daily utilization of system 100. FIG. 14 is a flowchart describing a process for providing reports in accordance with an embodiment of the present invention.

At step 1410, a user 150 selects the “Dispensings” or “Daily Utilization” option from the Reports menu of menu bar 310 of FIG. 3. In response, server 170 returns an appropriate search window for searching dispensing transactions or daily utilization of the system 100 (step 1415). FIGS. 16U and 16V illustrate exemplary screens returned by server 170 in step 1415 for searching dispensing reports and daily utilization reports, respectively. At step 1430, the user 150 enters search criteria into the search screen returned by server 170. In response, the server 170 returns a dispensing transaction report or daily utilization report based on the search criteria entered by the user 150 (step 1440).

FIG. 16W illustrates an exemplary daily utilization report returned by server 170 in step 1425. It will be appreciated that such reports can permit users 150 to view items dispensed by different physicians using system 100 over a specified time period. In addition, if multiple offices 105 are serviced by system 100, then utilization of system 100 by all of the offices 105 can be viewed in a single utilization report.

FIG. 16D previously discussed herein illustrates an exemplary dispensing report returned by server 170 in step 1425. It will be appreciated that such a report allows user 150 to view the dispensing history, lot number, including physician and staff who initiated the dispensing, patient gender, and date of dispensing associated with the selected lot. In various embodiments, a screen shot of the drug label sheet can be returned by server 170 for viewing by user 170 in response to the user 150 clicking on the name of the drug and/or the control number in the far right column of the transaction report. FIG. 16E illustrates an exemplary screen shot of such a drug label sheet.

In addition to the embodiments set forth above, various embodiments of system 100 can be implemented to provide for the generation and display other reports including, but not limited to financial reports based on collection amounts, reports based on lot expiration dates, reports based on lot numbers, and/or other reports based on any of the information contained in data records 190 of server 170.

In another aspect of the present invention, various embodiments of system 100 can provide status alerts to a user 150, thereby informing the user 150 of circumstances warranting the user's 150 immediate attention. By clicking on the alert, the user 150 can be directed to an appropriate screen for attending to the alert status.

FIG. 15 is a flowchart describing a process for providing status alerts in accordance with an embodiment of the present invention. At step 1510, server 170 detects an alert status. Various alerts can be supported, including but not limited to: “Reorder” alerts triggered when inventory on hand of for a particular item has fallen below a specified minimum quantity; “Delivery” alerts triggered when delivery of an item is in queue; “Invoice” alerts triggered when an invoice for inventory items is in queue; “Expiration Date” alerts triggered when a lot is nearing its expiration date; and “Rx Queue” alerts triggered when there are items in the prescription queue waiting to be dispensed.

At step 1520, the server 170 notifies the user 150 of the detected alert status. In various embodiments, such notification can be performed by causing the status alert light of menu bar 310 to blink and displaying the alert type in the status window 350 of the main screen illustrated in FIG. 3. The user 150 can then select an alert to be attended to (step 1530). In response, server 170 returns an appropriate window (i.e. a screen displayed in a browser running on computer 120 (step 1540) for the user 150 to respond to the selected alert (step 1550). For example, for Reorder alerts, the user 150 can be directed to a screen for placing an order for the depleted items. For Delivery alerts, the user 150 can be directed to a screen for accepting incoming deliveries. Similarly, for Invoice alerts, the user 150 can be directed to a screen for accepting incoming invoices. For Rx Queue alerts, the user 150 can be directed to a screen for dispensing items in the prescription queue.

It will be appreciated that the scope of the present invention is not limited by the particular embodiments set forth herein. Other appropriate variations, whether explicitly provided for or implied, are contemplated by the present disclosure. For example, system 100 can be implemented to perform the various functionality described herein in relation to additional offices 105 and/or medical practices as desired. In addition, system 100 can be implemented to provide for the printing of forms for physician-assisted pharmaceuticals (“PAP”), and functionality for tracking inventory based on such PAP products. For example, particular inventory items can be designated as PAP products available for dispensing to particular patients and/or groups of patients.

1. A method for managing inventory of a medical practice, the method comprising:
maintaining inventory data records associated with items to be dispensed by the medical practice;
electronically receiving a lot number associated with one of the items;
verifying the lot number with the inventory data records;
updating the inventory data records in real time in response to a dispensing transaction; and
storing a record of the dispensing transaction.

2. The method of claim 1, wherein:
at least one of the steps is performed by a web-enabled server of an integrated dispensing and inventory tracking system.

3. The method of claim 2, wherein:
the items to be dispensed comprise repackaged drugs.

4. The method of claim 3, wherein:
the inventory data records comprise information selected from the group consisting of:
a user-defined inventory category;
a minimum quantity associated with one of the items to be dispensed;
a maximum quantity associated with one of the items to be dispensed; and
a quantity on hand associated with one of the items to be dispensed.

5. The method of claim 3, further comprising:
issuing a delivery notification in response to an incoming delivery of inventory; and
updating the inventory data records in real time in response to a user acceptance of the incoming delivery.

6. The method of claim 3, further comprising:
detecting an alert status;
notifying a user of the alert status;
receiving a user selection of the alert status; and
transmitting a graphical user interface to the user to permit the user to respond to the alert status.

7. The method of claim 6, wherein:
the alert status is detected if a quantity on hand associated with one of the items to be dispensed is less than a minimum quantity associated with the item.

8. The method of claim 3, further comprising:
generating a dispensing transaction report.

9. The method of claim 3, further comprising:
generating a utilization report.

10. A method for interacting with an integrated dispensing and inventory tracking system, the method comprising:
selecting an inventory record maintained by the system, wherein the inventory record is associated with an inventory item tracked by the system, wherein the system maintains product lot information associated with the inventory item;
reviewing the inventory record; and
editing the inventory record.

11. The method of claim 10, wherein:
the method is performed by a user located in an office of a medical practice.

12. The method of claim 10, further comprising:
dispensing an item from an inventory of the medical practice to a patient.

13. The method of claim 12, wherein the dispensing step comprises:
selecting a physician from a provider list;
selecting a prescription, the prescription identifies the item;
retrieving the item from inventory; and
scanning a barcode associated with the item.

14. The method of claim 12, wherein the dispensing step comprises:
selecting a prescription from a prescription queue, the prescription identifies the item;
retrieving the item from inventory; and
scanning a barcode associated with the item.

15. The method of claim 11, wherein:
the inventory record comprises formulary data.

16. The method of claim 11, wherein:
the inventory record comprises a user-defined inventory category.

17. The method of claim 11, wherein:
the inventory record comprises an inventory quantity.

18. An integrated dispensing and inventory tracking system, the system comprising:
a server in communication with the Internet;
a web site provided by the server;
application software running on the server for tracking inventory of a medical practice; and
data records stored by the server, the data records comprising information selected from the group consisting of:
a user-defined inventory category,
a minimum quantity associated with a tracked inventory item,
a maximum quantity associated with the tracked inventory item,
a quantity on hand associated with the tracked inventory item, and
a lot number associated with the tracked inventory item.

19. The method of claim 18, wherein:
the tracked inventory item comprises medical supplies.

20. The method of claim 18, wherein:
the tracked inventory item comprises repackaged drugs.
